(19) United States
(12) Patent Application Publication
(10) Pub. No.: US 2012/0054814 A1
(43) Pub. Date: Mar. 1, 2012

(54) Portable Internet Media Viewer

(76) Inventors: Rajiv Porayath, Northbrook, IL (US); Dan Mapes-Riordan, Evanston, IL (US)

(21) Appl. No.: 13/221,641

(22) Filed: Aug. 30, 2011

Related U.S. Application Data
(60) Provisional application No. 61/378,034, filed on Aug. 30, 2010.

(51) Int. Cl. H04N 7/173

(52) U.S. Cl. 725/110

(57) ABSTRACT

A media viewer having a processor, a display responsive to instructions from the processor, and a plurality of channels provided on the display wherein at least one of the channels has one or more Internet media sites linked thereto.

### CROSS-REFERENCE TO RELATED APPLICATIONS

This application claims the benefit of U.S. Provisional Patent Application Ser. No. 61/378,034 filed on Aug. 30, 2010, and herein incorporated by reference.

### TECHNICAL FIELD OF THE INVENTION

The present invention relates to the Internet, and more particularly, to techniques for obtaining Internet content.

### BACKGROUND OF THE INVENTION

Most Internet content (e.g., TV shows) is viewed on personal computers (PCs) such as laptops and netbooks. Although these devices are capable of accessing and displaying Internet content, they are not specifically designed for this purpose. For example, PCs can take over a minute to boot up. After boot up, a web browser needs to be run. After the web browser is opened, the desired website must be found (perhaps with a favorite shortcut or bookmark) and accessed. Once the desired website is accessed, the desired content must be found within the website. Only now can the user select the desired content and begin delivery and enjoyment. Contrast the above sequence of events needed to experience content with a non-Internet device such as a television or radio. For these devices the user simply turns it on and selects the desired channel. In an embodiment, the present invention addresses the ease of use in accessing and experiencing Internet content that consumers are accustomed to with traditional entertainment devices.

In the prior art, it has been found that U.S. Pat. No. 6,025,837 purports to disclose an interactive entertainment system having a program provider which distributes video content programs to multiple subscribers over a distribution network. Each subscriber has a user interface unit which receives the digital video program and converts it for display on a television, monitor, or other display unit. The user interface unit has a processor and memory. An electronic programming guide (EPG) resides in the memory and is executable on the processor to organize programming information that is descriptive of the programs supplied over the interactive entertainment system. The EPG supports a user interface (UI) which visually correlates programs titles to scheduled viewing times. A hyperlink browser also resides in memory and is executable on the processor. One or more hyperlinks, which reference target resources containing interactive content related to the video programs, are integrated as part of the EPG UI. The hyperlinks can be placed in the program titles, channel tiles, or description area, and can be situated alone or embedded within other text. When a viewer activates a hyperlink within the EPG, the user interface unit launches the browser to activate the target resource specified by the hyperlink. The data retrieved from the target resource is then displayed on the display unit. The viewer can also drag a particular program or channel label from its location within the EPG UI and drop the label at another location on the display unit. This drag-and-drop operation associates an instruction with the label that will execute in response to activation of the label. The instruction might cause the visual display unit to tune to the program or channel represented by the particular label, or to initiate procedures to record the program when it begins playing, or to jump to a related target resource, such as a Web site.

U.S. Pat. No. 6,195,692 B1 purports to disclose an Internet on-demand system for television presents Internet content and traditional television programming as part of a single coherent interface. The system includes a server and a client capable of providing a dynamic graphical user interface. The server queries the client regarding its available data stream connections, including telephone modems, cable modems, and digital satellite broadcasting, in order to determine the most efficient delivery of different types of data through all of the available bandwidth connections. The system can display an Internet gateway interface which actively scrolls through and highlights links to selected web pages which are organized according to templates corresponding to their content. The web pages are presented on the graphical user interface as channels as part of the same milieu as channels of traditional television programming The user can select a channel from a rotary menu wheel. An intelligent agent passively filters selected web pages for a user to explore based on the user's past pattern of usage of the client. The efficient delivery of data allows the client to present text, graphics, video, audio and other multimedia information from a web page over the Internet as a coordinated presentation.

U.S. Pat. No. 6,268,849 purports to disclose an Internet television program guide system that allows a user at a multimedia system to access television program listings containing embedded real-time data over an Internet communications link. The television program listing may be for a sporting event that is currently being broadcast and the real-time data may be the current score of the event, the current weather where the event is taking place, or any other suitable real-time information on the event. The real-time data may be presented in the form of video stills, video clips, textual information, audio clips, or suitable combinations of such media. The user can perform database searches on the program guide listings to search for a desired program. If desired, the user can obtain additional information on a selected program by accessing an associated web page.

U.S. Pat. No. 6,968,364 purports to disclose a system and method to facilitate selection and programming of at least one of audio and visual programs. A first computer is operative to connect to a second computer for filtering through a plurality of audio and/or visual programs based on selection criteria to provide a filtered representation of programs. A program from the filtered representation of programs may be selected at the first computer so as to cause a token indicative of the selected program to be assigned to a recipient operative to receive the token. The recipient may be a user at the first computer, a third computer, or an entertainment appliance. The token represents the selected program with sufficient particularity to program an entertainment system based on the token to record the program represented by the token.

U.S. Pat. No. 6,993,721 purports to disclose a system and method for enabling a user to navigate among a plurality of Internet websites of interest to the user, the system includes a graphical user interface which includes a guide for enabling the user to navigate among the Internet websites, and to obtain access to a selected one of the Internet websites. The guide includes an array of web channel buttons, each of which includes a web channel number and a web channel title, and each of which is associated with an enables access to at least one Internet website. The Internet websites associated with each web channel button may comprise Internet websites commonly accessed by the user or selected for the user, which are relevant to topics of interest to the user. An Internet program guide accessible from the web channel guide enables customization of at least one Internet website associated with each of the array of web channel buttons, so as to enable further access to Internet websites of Internet to the user. Each web channel button can be efficiently activated to enable selection and access to the Internet websites of interest to the user. A guide strip identifies the Internet website selected and presented in a display, for integrated navigation between Internet websites and television channels.

U.S. Pat. No. 7,254,785 purports to disclose a user selection interface system comprising of one or more circular selectors linked to selectable characteristics, and a display linked to the selectors, for display of an image which corresponds to the selected characteristics. The interface is typically linked to a database comprising stored image and other information which corresponds to the selectable characteristics, whereby an image that corresponds to an item which meets a selected characteristic is retrieved and displayed. Information other than the image which corresponds to the selectable characteristics may also be retrieved and displayed. In some embodiments, the stored images comprise a single image, which matches all the selected characteristics. In alternate embodiments, the displayed image comprises a composite image that is based upon stored images which correspond to different selected characteristics. In some embodiments, the user selection interface comprises a graphic user interface. In alternate embodiments, the user selection interface comprises a mechanical interface. Some preferred embodiments of the user selection interface provide links for merchandising functions, such as for ordering, purchasing, inventories, and/or shipping.

U.S. Pat. No. 7,340,761 purports to disclose an Internet-enabled television system providing an electronic program guide for the radio (radio EPG) depicting radio programs available via the Internet. The radio EPG displays the programming available for a plurality of radio stations and time slots. The radio EPG is interactive in that a user may select a radio program for immediate playback or future recording. Radio programs are continuously received and cached by the Internet-enabled television system such that a user may be able to select and listen to an earlier-broadcast radio program listed in the radio EPG.

U.S. Pat. No. 7,424,447 purports to disclose a system and methods for enabling a user to create a list of items on a portable computing device, to communicate with external devices to locate each of the items available on the list within a geographically limited area, to provide users with visual or aural cues as to the location of items on the list, to progress through the list of items as each item is selected or rejected, and providing discounts toward, information about, or alternatives to the available items on the list.

U.S. Pat. No. 7,490,295 purports to disclose a user-activatable dashboard containing any number of user interface elements, referred to herein as “widgets,” for quick access by a user. In response to a command from a user, the dashboard is invoked and the widgets are shown on the screen. The user can activate the dashboard at any time. Once the dashboard has been activated, the user can interact with any or all of the widgets, and can configure the dashboard by adding, deleting, moving, or configuring individual widgets as desired. When the user wishes to return to the normal user interface he or she was working with, the user issues a command causing the dashboard to be dismissed. Once the dashboard has been dismissed, the previous user interface state is restored, allowing the user to resume normal interactions with the operating system.

U.S. Pat. No. 7,954,064 purports to disclose systems, methods, computer-readable mediums, user interfaces and other implementations disclosed for organizing, managing and presenting widgets in display areas associated with multiple dashboard environments. In some implementations, a first display area associated with a first dashboard environment is configured for displaying at least one widget from a first set of widgets. As second display area associated with a second dashboard environment is configured for displaying at least one widget from a second set of widgets.

U.S. Patent Application Publication Number 2010/0199311 purports to disclose caching related technology, in which a time needed to begin rendering network-based video content without caching a decoded version of the content is determined and, the determined time to begin rendering the network-based video content is compared to a threshold time. When the determined time to begin rendering the network-based video content exceeds the threshold time, an initial portion of the network-based video content is pre-transcoded to a faster video codec format, and the pre-transcoded initial portion of the network-based video content is stored in electronic storage associated with a media system of a user.

U.S. Patent Application Publication Number 2010/0215336 purports to disclose methods, apparatus and products for administering a time-shifting cache in a media playback device where the media playback device receives from a digital media provider a digital media stream of digital media content and administering the time-shifting cache includes caching the digital media content of the digital media stream in the time-shifting cache; dynamically identifying one or more non-preferred segments of the cached digital media content; and managing the time-shifting cache in independence upon the identified non-preferred segments.

The prior art references above, U.S. Pat. Nos. 6,025,837, 6,195,692, 6,268,849, 6,968,364, 6,993,721, 7,254,785, 7,340,761, 7,424,447, 7,490,295 and 7,954,064 and U.S. Patent Publication Nos. 2010/00199311 and 2010/0215336 are incorporated herein, by reference.

### SUMMARY OF THE INVENTION

In an embodiment, the present invention brings the Channel Surfing experience from the Television world to the Internet world. In an embodiment, the invention arranges the channels in a sequence, similar to the channels available on TV. The user can flip between channels, similar to channel surfing on a TV. In the TV channel surfing experience, the content in the channels is available on tuning into a specific channel. On the Internet, accessing content requires the loading of the content from the Internet and the associated delay. One notices this when accessing a web page using a browser or viewing video on youtube.com. In contrast, the invention brings the channel surfing experience to the Internet by caching and preloading media content. Content available on each channel is cached prior to the user accessing the content, ensuring that there is no delay in loading content, this provides an experience similar to switching channels on the TV.

In an embodiment, the present invention is a mechanical device with software implementing features in accordance with the present invention. In another embodiment, the present invention is set forth as a software component running on a third party mechanical devices such as a TV, Tablet, Computer, Laptop, Netbook, Mobile Phone or similar device.

Other embodiments, systems, methods, features and advantages of the present invention will be, or will become, apparent to one having ordinary skill in the art upon examination of the following drawings and detailed description. It is intended that all such additional systems, methods, features, and advantages included within this description be within the scope of the present invention, and be protected by the accompanying claims.

### BRIEF DESCRIPTION OF THE DRAWINGS

The invention may be better understood with reference to the following drawings. The components in the drawings may not be necessarily to scale, emphasis instead being placed upon illustrating the principles of the invention. In the drawings, like reference numerals designate corresponding parts throughout the several views.

FIG. 1 is a block diagram of the electronic components used in an embodiment in accordance with the present invention. The electronic components include, but are not necessarily limited to, a microprocessor and associated semiconductor chipsets, memory for storage, visual display (e.g., screen), user controls (e.g., buttons, keys), network interface and audio interface (e.g., speakers);

FIG. 2 is a block diagram of the software components used in an embodiment in accordance with the present invention. It includes the operating system, on which the software program implementing an embodiment of the present invention is run (i.e., Main Program) and associated software to control the display, audio, network interface, and user interface;

FIG. 3 is a block diagram of the software program Main Program in accordance with an embodiment of the present invention. This includes the implementation of the embodiment. Internet content arranged as Channels. It also includes the Remote Updates component to keep the content cached and provide the Channel Surfing experience to Internet content;

FIG. 4 is a block diagram of the Channels wherein the Channels are content aggregated from the Internet. Each Channel contains a specific set of contents;

FIG. 5 is a block diagram of the My Weather Channel showing the different types of weather content or media within this channel and how it can be organized;

FIG. 6 is a block diagram of the My Media Channel showing the different type of social content or media within this channel and how it is organized;

FIG. 7 is a block diagram of the My News Channel showing the different type of content within this channel and how it is organized;

FIG. 8 is a block diagram of the My TV Channel showing the different type of content within this channel and how it is organized;

FIG. 9 is a block diagram of the My Radio Channel showing the different type of content within this channel and how it is organized;

FIG. 10 is a block diagram of the My Email Channel showing the different type of content within this channel and how it is organized;

FIG. 11 is a block diagram of the My Maps Channel showing the different type of content within this channel and how it is organized;

FIG. 12 is a block diagram of the My Traffic Channel showing the different type of content within this channel and how it is organized;

FIG. 13 is a block diagram of the Server System that maintains optimum performance of the Media Viewers in the field; and,

FIG. 14 is an illustration of a mechanical embodiment in accordance with the present invention.

### DETAILED DESCRIPTION OF THE INVENTION

The following descriptions of detailed embodiments are for exemplifying the principles and advantages of the inventions claimed herein. They are not to be taken in any way as limitations on the scope of the inventions.

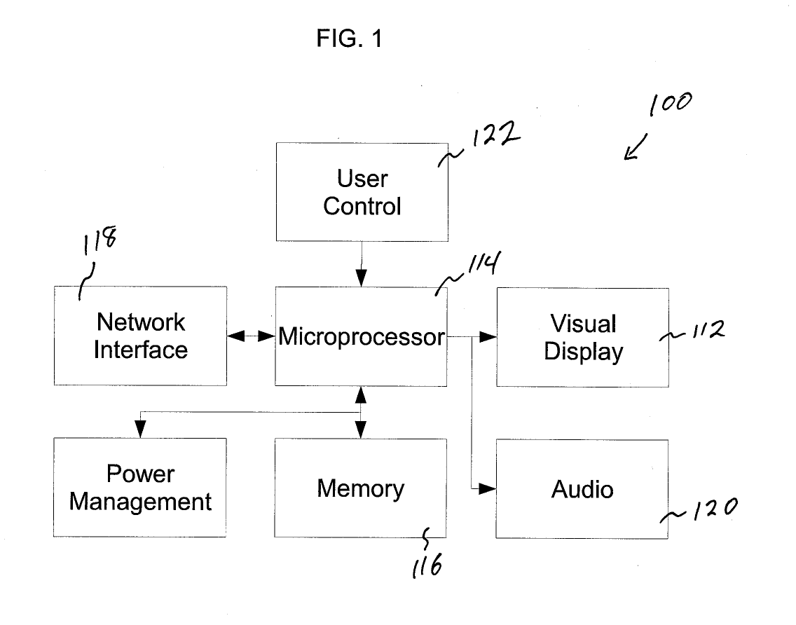

In an embodiment, a mechanical and software means are provided to access Internet content. As shown in FIG. 1, the mechanical embodiment of the media viewer 100 includes a conventional visual display 112, a conventional processor or microprocessor 114 and associated conventional circuitry with semiconductor memory 116, a chip 118 to connect wirelessly to the Internet (e.g. WiFi, Cellular Internet or the like), a conventional audio interface 120, and conventional user controls 122. As will be appreciated by those having ordinary skill in the art, the display is responsive to instructions from the processor. Stated another way, the processor dictates, directly or indirectly, what is shown or provided on the display.

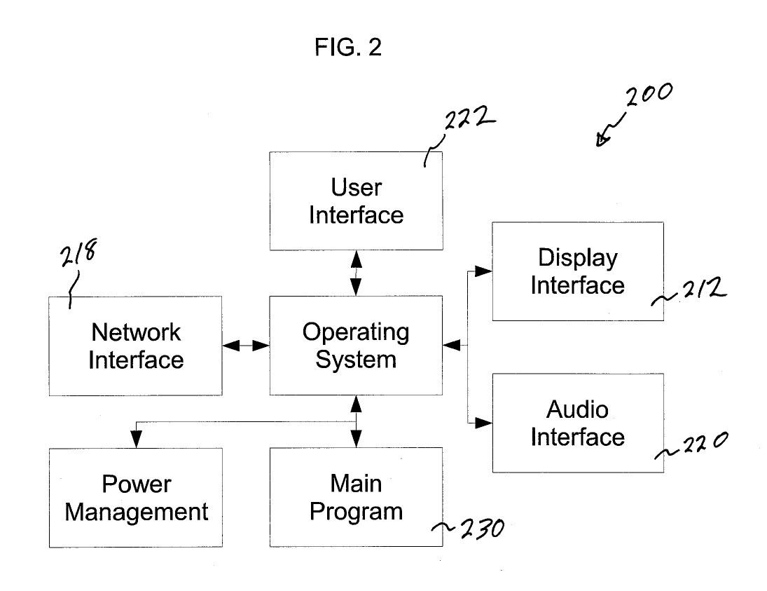

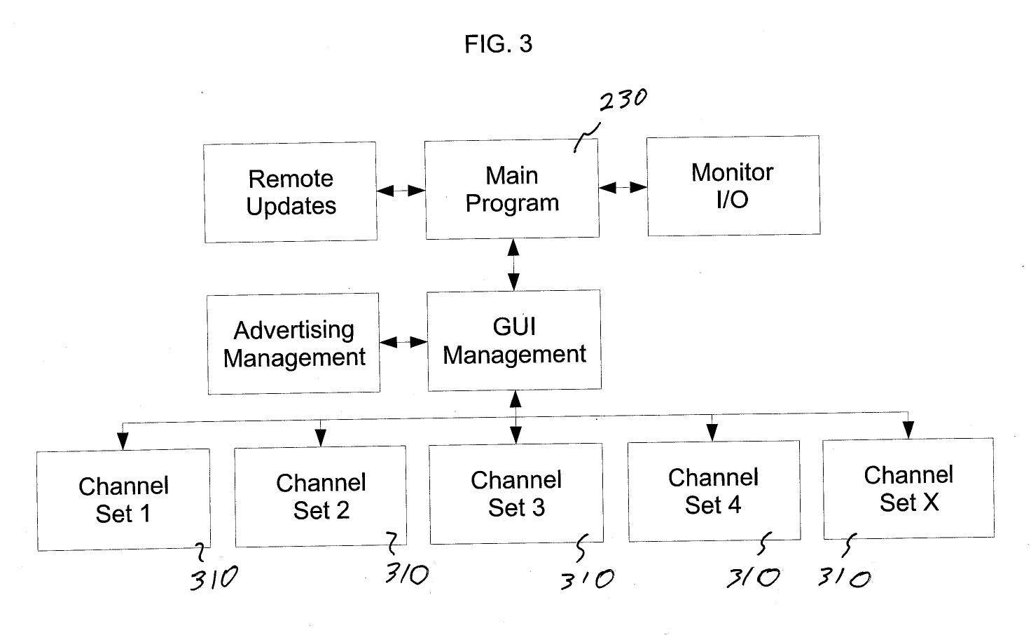

As shown in FIG. 2, the software 200 is organized around an operating system (such as Linux) with an interface 212 for controlling the display 112, an interface 218 for connecting to the Internet, an interface for managing memory, an interface 222 for the user controls 122 and an interface 220 for the audio 120. A software program (i.e., Main Program 230) runs on the operating system and performs functions in accordance with the present invention in software. As shown in FIG. 3, the Main Program 230 monitors peripheral input and output such as pushbuttons and Internet data, manages content caching and remote firmware updates, manages the displaying of ads, and controls the graphical user interface (GUI) directing the Internet content as selected by a user.

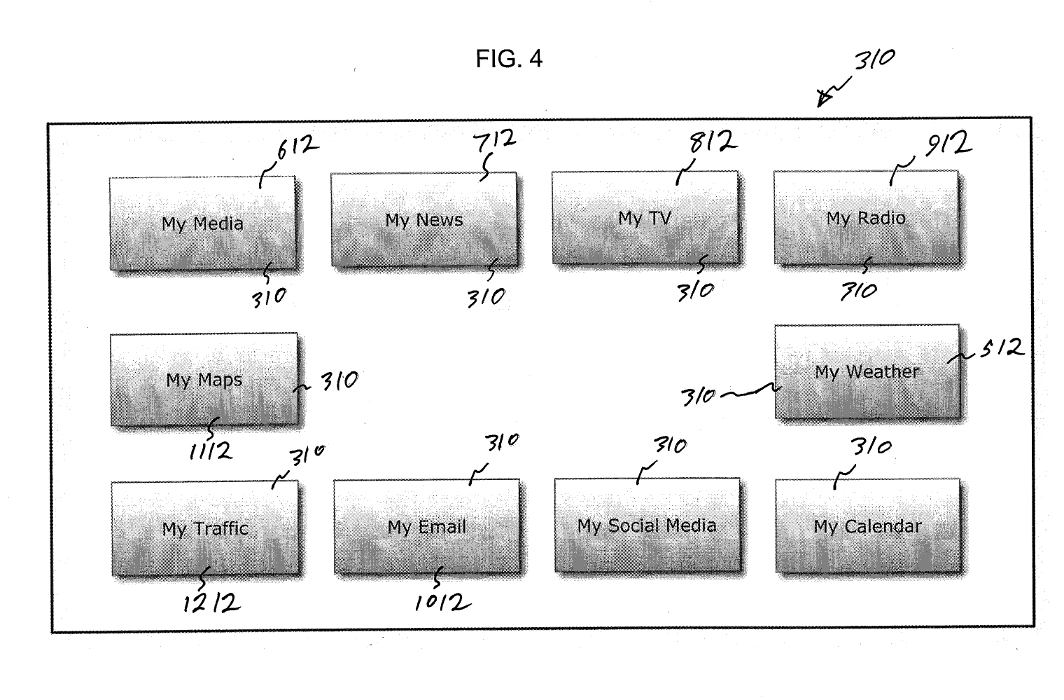

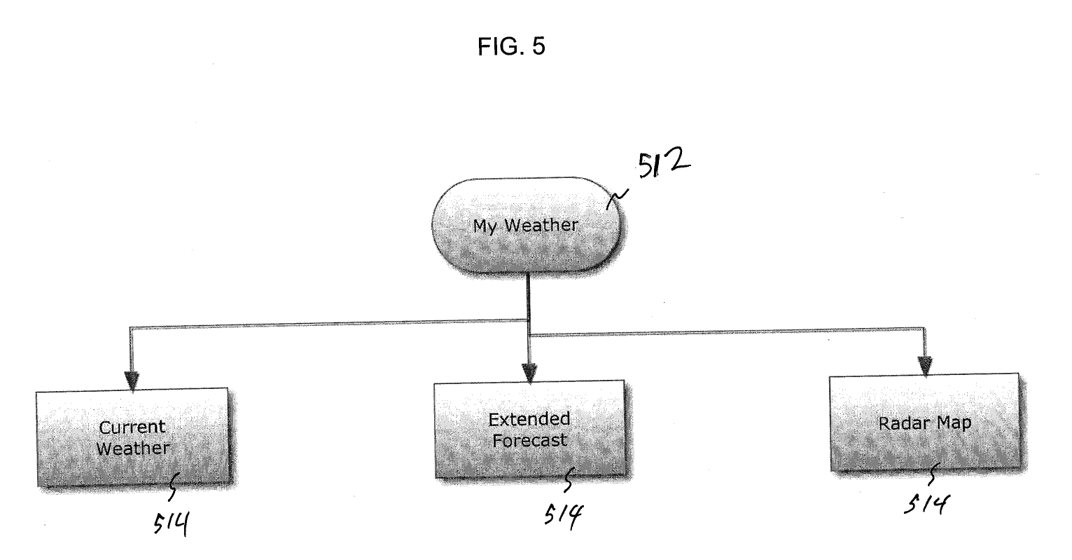

As shown in FIG. 3 and FIG. 4, in an embodiment, content is aggregated from the Internet into a number or plurality of Channels 310 provided for viewing on the display 112. Each Channel 310 is an aggregation of content, from one or more Internet media sites, under a specific category 312 (e.g. news, social networks, emails, radio, etc.). This is similar to a TV Channel. For example, the TV program the Weather Channel shows weather related content. In a similar manner, as shown in FIG. 5, the a My Weather Channel 512 is created as a collection of weather-related content 514 from the Internet (e.g. current weather, weather forecast, Doppler radar)

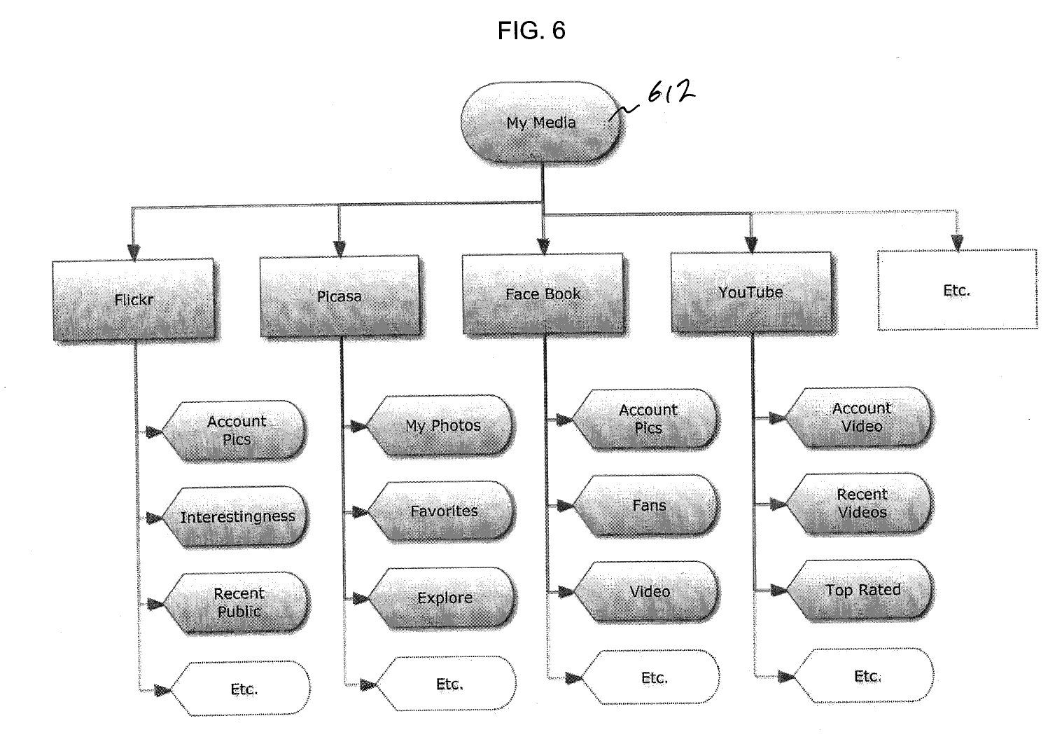

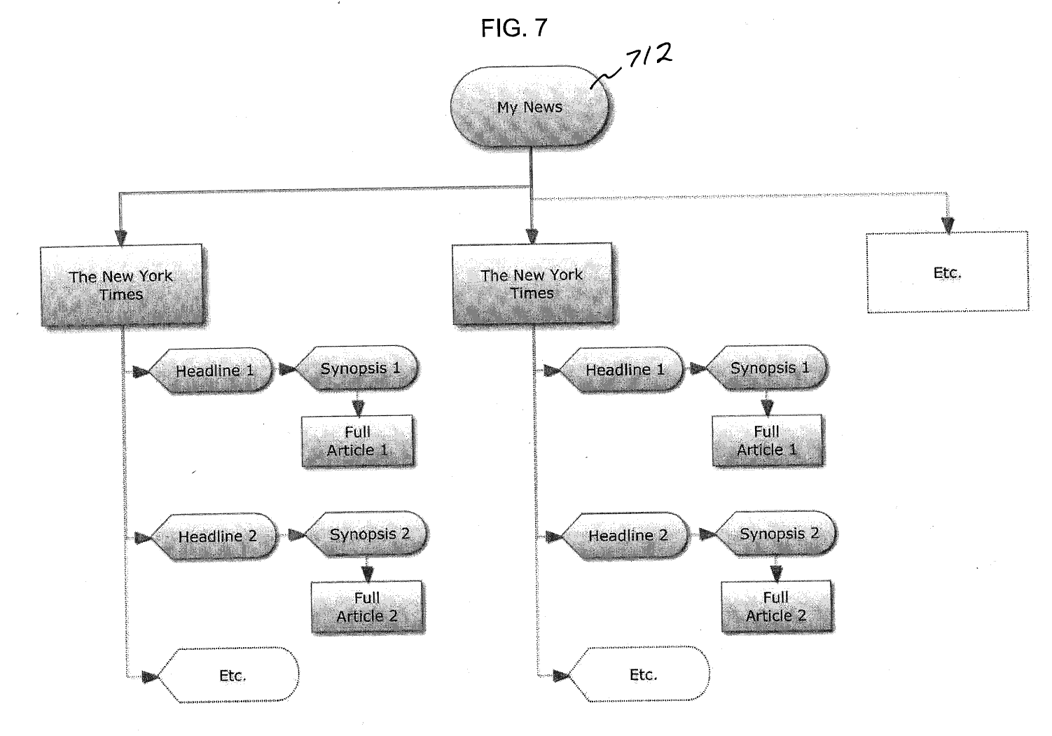

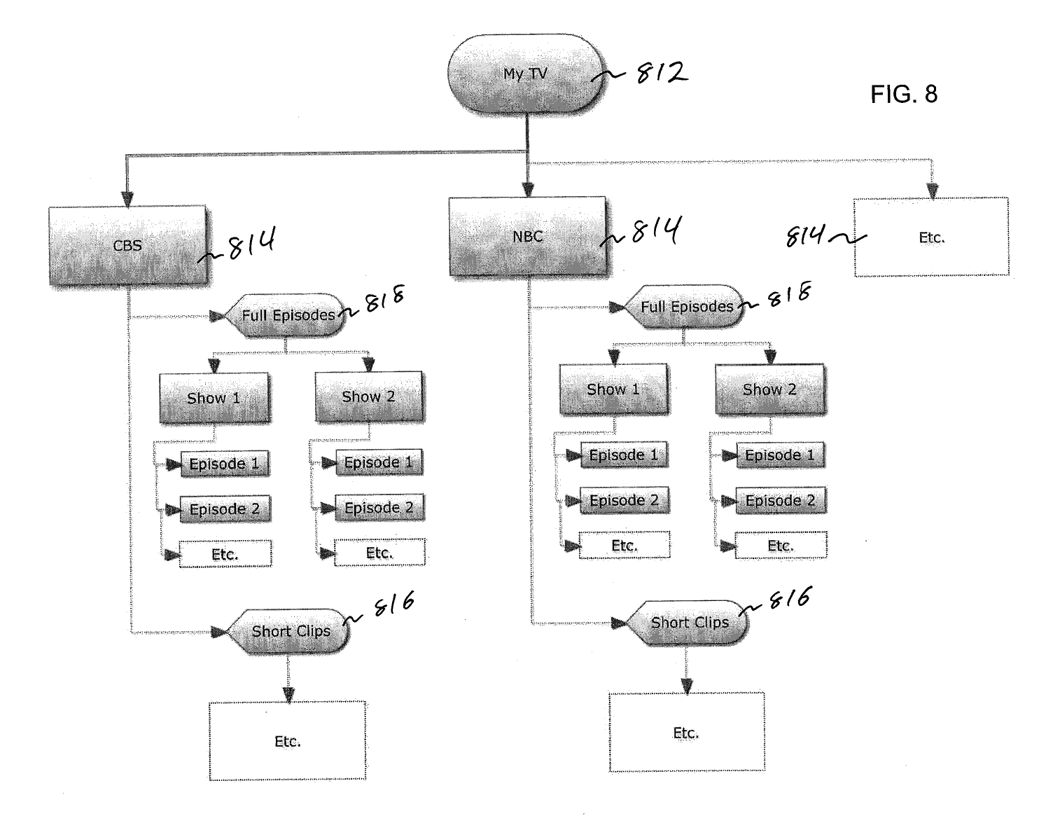

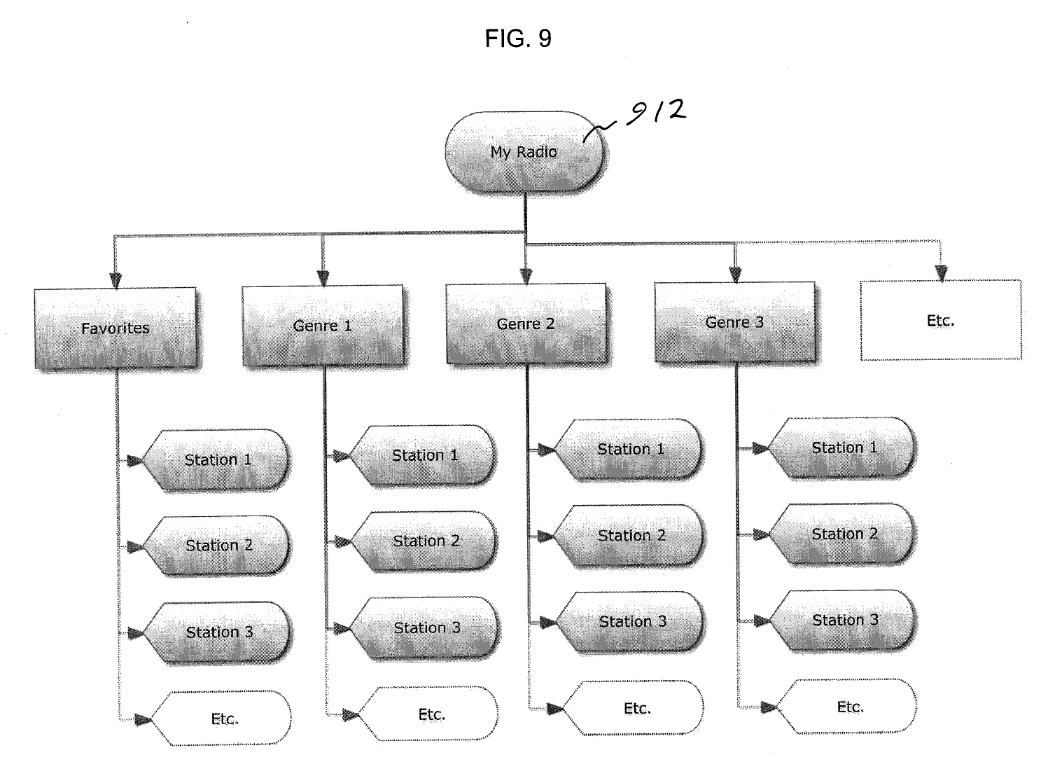

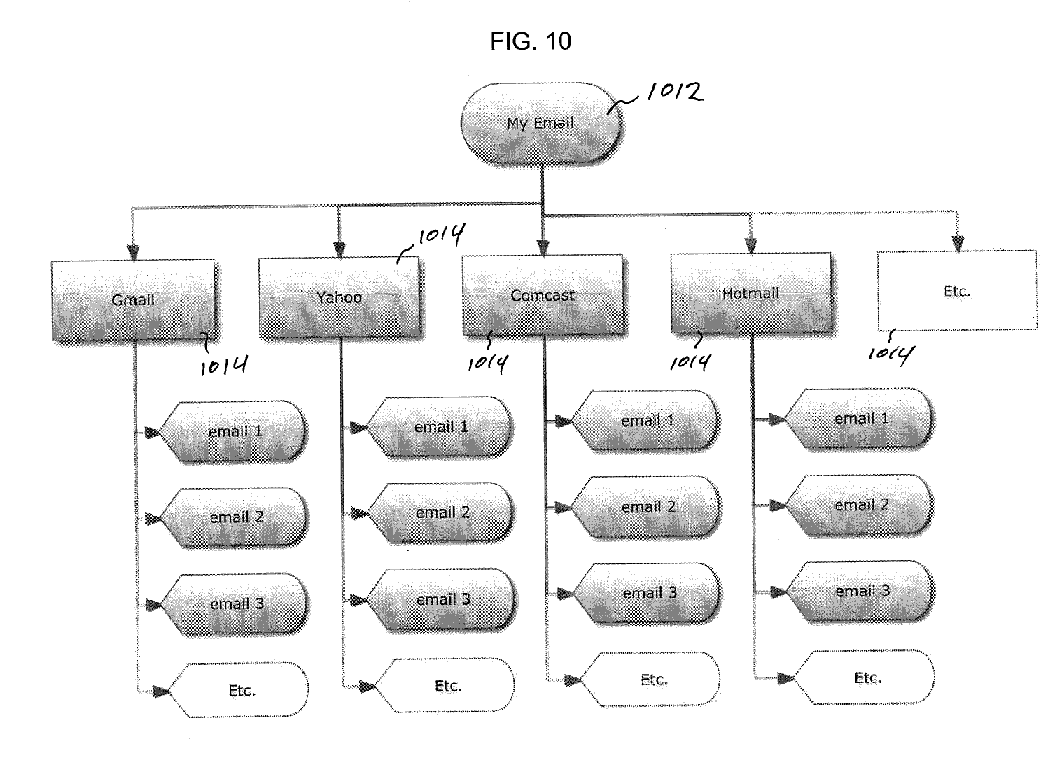

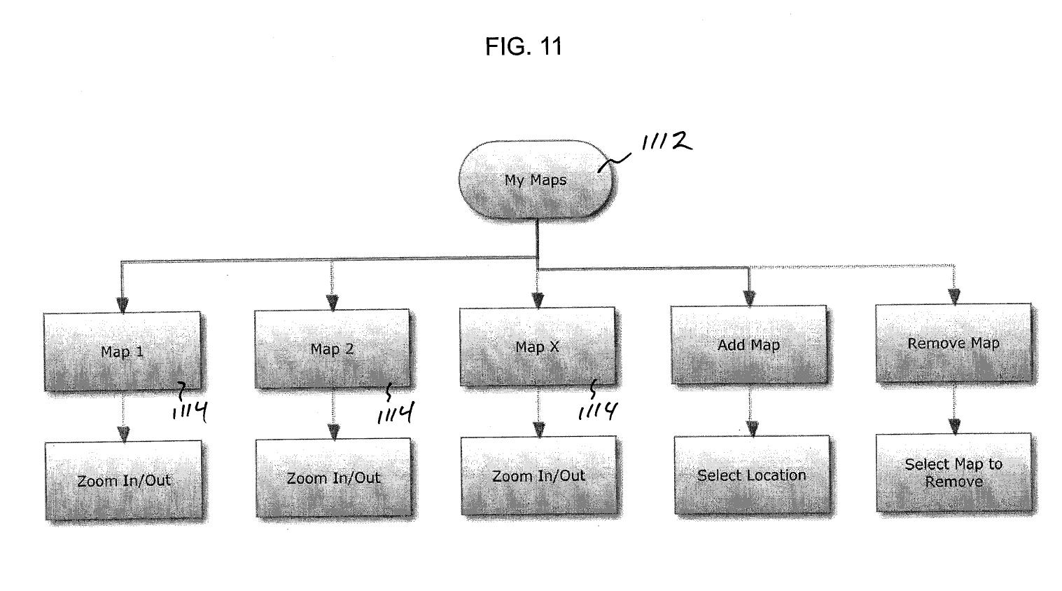

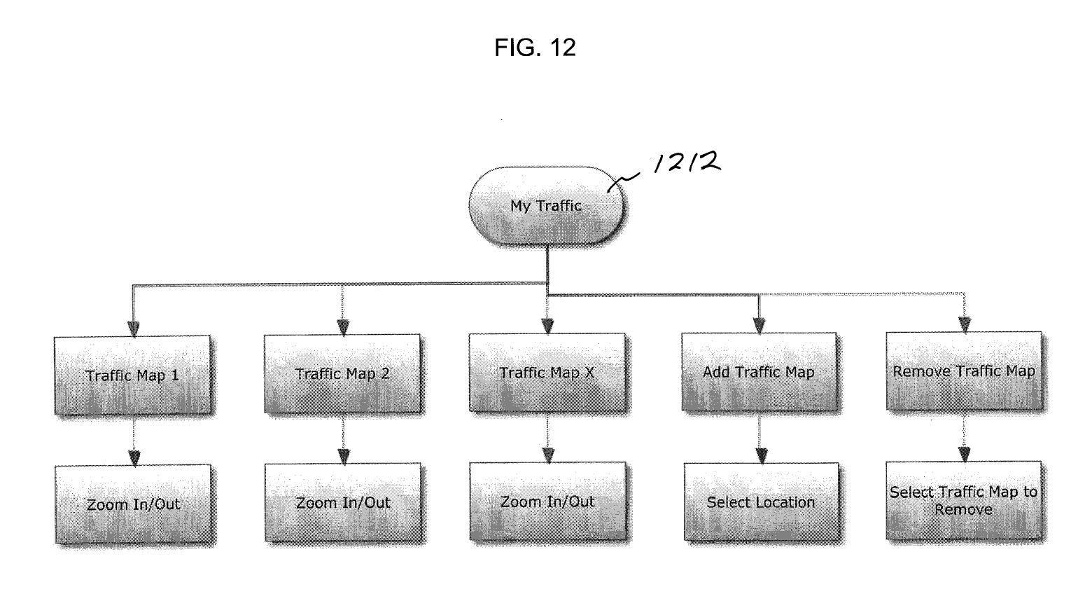

FIGS. 6 to 12 depict examples of menu structures for specific Channel sets 310. FIG. 6 depicts the My Media channel set 612. In these Channels the user can choose between various Internet media sites such as Flickr, Picasa, Face Book, You Tube, etc. Photos and videos can be accessed within each site as organized by each site's structure. FIG. 7 shows the menu structures of different news Channels. As a user selects a particular channel, they are shown the latest headlines within that Channel. When a headline is selected, a brief synopsis is displayed. Selecting a synopsis brings up the full article that can be read. FIG. 8 depicts the My TV channel set 812. The top menu shows various media content providers 814. Underneath each provider 814 lists short clips 816 and full episodes 818 offered on the Internet. Underneath is a list of shows and episodes that are available. FIG. 9 depicts the menu structure for the My Radio Channel set 912. In these Channels the radio stations are organized by genre (e.g., Pop, Country, Classical, News, etc.). FIG. 10 shows the menu structure for My Email Channel set 1012. From these Channels a user can access their email accounts 1014 and view the email in their inbox. Note that the first time a user attempts to access an email account they will be prompted to input (via virtual keyboard) their email address and password as well as other information specific to the particular account. FIG. 11 depicts the My Maps Channel set 1112. In this set, maps 1114 can be viewed with a zoom in/out feature. The user can also add new maps and select previously added maps for removal. FIG. 12 shows the menu structure for the My Traffic Channel set 1212. These channels are similar to the My Maps Channel set 1112 depicted in FIG. 11 except the road and traffic information is also displayed.

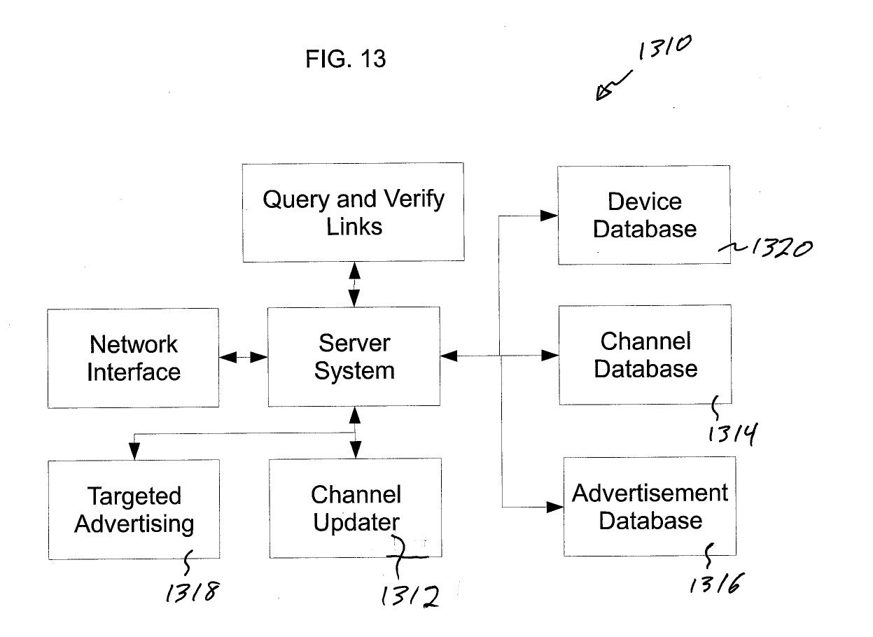

In an embodiment, another feature is the system for adding and updating the Internet links associated with the different Channels contained in the content viewers. A block diagram summarizing the functionality of the Server Software 1310 is shown in FIG. 13 wherein the Server Software can reside on a remote computer or server in communication with the Media Viewer 100. One of the functions of the Server Software 1310 is to maintain valid links for the Channels 310 by continually querying the links to verify they are working. If a Channel link is found to be broken, the maintainer of the Software System can manually update the link. The maintainer can also manually update or add links as needed. Once a Link change is detected and updated the Channel Updater 1312 manages the uploading of the new link to each Media Viewer in the field.

The Server Software 1310 maintains an up-to-date database of Media Viewer devices in the field. Information contained in this Device Database 1314 includes device IDs, owner information (e.g., demographics), current firmware version, last IP address, list of channels, etc. For example, each time a Media Viewer is powered on by a user, it will make contact with the Server Software 1310 and check for new firmware, update Channel links, pass back statistics regarding Channel access, and if necessary, update owner information. These operations will take place in the background without notice from the user unless specific information is needed.

The Channel Database 1314 maintains a list of all Channels that are compatible with the Media Viewer. Information in this database includes the Internet links associated with each Channel 310 and statistics related to the popularity of each channel as determined by regular queries/uploads of/from each Media Viewer.

The Advertisement Database 1316 contains links to advertisements either located remotely or residing on the server. Ads can be in the form of banner lines above or below Channel content or full display ads to be inserted between channel views. This database contains information regarding the location of each ad, the target audience for each ad, duration of ad, and presentation statistics.

The function of the Targeted Advertising function 1318 in FIG. 13 is to find high correlations between the information in the Device 1320, Channel 1314, and Advertisement Databases 1316 so the ads can be best targeted to the desired audience. For example, if it is found that a certain Channel 310 is highly popular among a certain user demographic as listed in the Device Database 1320, then similar Advertisements listed in the Advertisement Database 1316 can also be assigned to be viewed for these Channels and Media Viewers. Such information can also be used to determine appropriate advertisement costs.

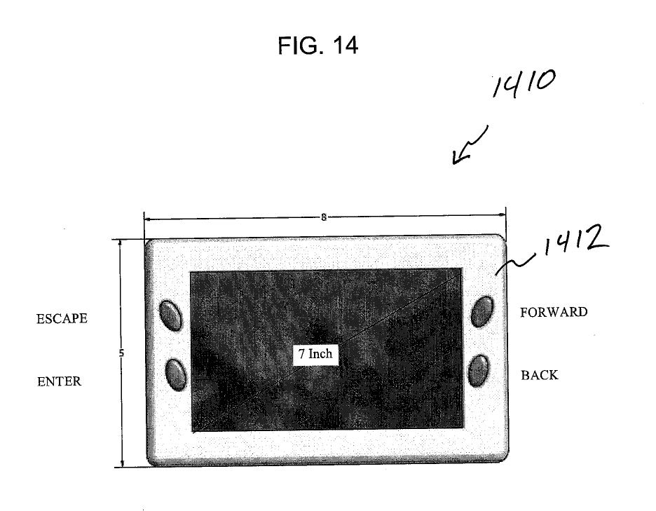

As noted above, in an embodiment, the invention can be realized in software that resides and runs on current hardware devices (e.g., iPad). In addition, the invention can also be realized with dedicated hardware such as is shown in FIG. 14. In this implementation a mechanical interface 1410 having housing 1412 is provided that provides the user with an experience similar to channel surfing on TV. A simple TV interface going back to the early days of TV included a channel selector, an ON/OFF switch and a Volume control switch. The mechanical interface 1410 has a limited number of input interfaces, a left/right scroll button, a select/escape button and an on/off button. This interface is mapped to the channels used to access content on the device. The mechanical interface is coupled to the channels in the mechanical instance of the present invention.

It should be emphasized that the above-described embodiments of the present invention are possible examples of implementations merely set forth for a clear understanding of the principles of the invention(s). Many variations and modifications may be made to the above-described embodiment(s) of the invention without substantially departing from the spirit and principles of the inventions. All such modifications are intended to be included herein within the scope of this disclosure and the present invention.

What is claimed is:

1. A media viewer comprising:
a processor
a display responsive to instructions from the processor; and,
a plurality of channels provided on the display wherein at least one of said channels has one or more Internet media sites linked thereto.

2. The media viewer of claim 1 wherein content from the one or more Internet media sites is cached or preloaded.

3. The media viewer of claim 2 wherein one of the channels comprising the one or more Internet media sites relates to weather.

4. The media viewer of claim 2 wherein one of the channels comprising the one or more Internet media sites relates to social media.

5. The media viewer of claim 4 wherein the social media includes at least one from the group comprising: FLICKR, PICASA, FACEBOOK, and YOUTUBE.

6. The media viewer of claim 2 wherein one of the channels comprising the one or more Internet media sites relates to news.

7. The media viewer of claim 6 wherein headlines are provided from the Internet media sites related to news.

8. The media viewer of claim 6 wherein synopsizes are provided from the Internet media sites related to news.

9. The media viewer of claim 6 wherein full articles are provided from the Internet media sites related to news.

10. The media viewer of claim 2 wherein one of the channels comprising the one or more Internet media sites relates to television.

11. The media viewer of claim 10 wherein full television episodes are provided from the Internet media sites related to television.

12. The media view of claim 10 wherein short clips of television programs are provided from the Internet media sites related to television.

13. The media viewer of claim 2 wherein one of the channels comprising Internet media sites relates to radio.

14. The media viewer of claim 1 wherein one of the channels comprising Internet media sites related to email accounts.

15. The media viewer of claim 14 wherein the email accounts includes at least one from the group comprising: GMAIL, YAHOO, COMCAST, and HOTMAIL.

16. The media viewer of claim 1 wherein one of the channels comprising Internet media sites relates to maps or traffic.

17. The media viewer of claim 1 wherein the link is updated.

18. An apparatus comprising:
a housing; and,
the media viewer of claim 1.

19. A method comprising the steps of:
displaying a plurality of channels wherein at least one of said channels has one or more Internet media sites linked thereto; and,
caching or preloading the content from the one or more Internet media sites.

20. The method of claim 19 further comprising the step of updating the link.
